(19) United States
(12) Patent Application Publication
(10) Pub. No.: US 2003/0177066 A1
(43) Pub. Date: Sep. 18, 2003

(54) Integrated marketing promotion system and method

(75) Inventors: Robert J. Zhang, Palo Alto, CA (US); Michael P. McCarroll, Redwood Shores, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Computer Sciences Corporation, a Nevada corporation,, El Segundo, CA

(21) Appl. No.: 10/356,396

(22) Filed: Jan. 31, 2003

Related U.S. Application Data
(63) Continuation-in-part of application No. 09/834,851, filed on Apr. 12, 2001.
(63) Continuation-in-part of application No. 09/834,855, filed on Apr. 12, 2001.
(60) Provisional application No. 60/353,275, filed on Feb. 1, 2002.

(51) Int. Cl. G06F 17/60

(52) U.S. Cl. 705/14

(57) ABSTRACT

A method for an integrated promotion system includes receiving a specification of a promotion, determining a point of sale server destined for the promotion, in response to the promotion, converting the specification of the promotion into a point of sale data packet, providing the point of sale data packet to the point of sale server, providing notice of a promotion to a first targeted customer in response to the point of sale data packet, providing a promotion benefit to the first targeted customer when the preconditions of the promotion are met, storing transaction data of the first targeted customer, when the first targeted customer meets the preconditions of the promotion, uploading the transaction data of the first targeted customer, generating a promotion report, in response to the transaction data of the first targeted customer, and providing the promotion report to the promoter system.

### CROSS-REFERENCES TO RELATED APPLICATIONS

This application claims priority to Provisional Application No. 60/353,275 filed Feb. 1, 2002. This application is a continuation-in-part of application Ser. No. 09/834,855 filed Apr. 12, 2001, and a continuation-in-part of application Ser. No. 09/834,851, filed Apr. 12, 2001. These applications are hereby incorporated by reference for all purposes.

### BACKGROUND OF THE INVENTION

The present invention relates to methods and systems for creating and distributing promotions across a computer network. Further, the present invention relates to methods and systems for specifying promotions and distributing promotions across a computer network.

Under economic theory, the law of supply and demand suggests that an equilibrium between the number of goods produced and a product price can be reached in the free market. However, not content with profits at such equilibriums, marketers and promoters have tried to find ways to attract buyers who would not have purchased the product at the equilibrium price. Such buyers may be termed “target buyers.” One conventional way to attract target buyers has been through the use of traditional paper-based coupons.

As is well known, coupons are detachable, possessable certificates that possess a monetary value. For example, typical coupons may be worth 1/10¢, 1/20¢, or the like. The real “worth” of traditional coupons are that they provide the bearer or presenter with proof of the right to exercise a predetermined bargain. For example, it allows the bearer to “save $1” off the price of a CD; it allows the bearer to “get one free” with purchase of “one;” and the like. Traditionally, marketers/promoters of products provide consumers with coupons to attract purchasers who otherwise would not have considered purchasing the product, i.e. target buyers.

A problem with traditional coupons includes that coupons often end up in the hands of buyers who are not targeted. This is because distributing coupons only to target buyers is virtually impossible. Although some coupons may be distributed to channels such as magazines, direct mailings, and the like that include a large percentage of target buyers, a significant percentage nevertheless reaches non-target buyers. These non-target buyers may include those willing to purchase the product even without the coupon. Accordingly, if non-target buyers uses the coupons to purchase a product, this directly reduces the amount of profit to the promoter. As an example, a promoter may create a promotion directed to Pepsi™ drinkers to try Coke™. To do so, the promoter offers coupons providing the bearer with a dollar off a six-pack of Coke™. However, it is virtually impossible to prevent a devoted Coke™ drinker from picking and redeem that coupon. This sort of common situation directly “siphons-off” manufacturer profits.

From a retailer point of view, a typical problem with “reward” or “loyalty” card systems promotions, is that it is difficult to estimate the number of redemptions of the promotion. Because, promotions are simply run for specified periods of time, any not by promotion budget, over-budget situations are common for such promotions.

Thus, in light of the above, what is needed in the industry are improved methods and apparatus for specifying promotions to users while reducing the drawbacks discussed above.

### SUMMARY OF THE INVENTION

The present invention relates to methods and systems for creating promotions and distributing promotions across a computer network. Further, the present invention relates to methods and systems for specifying and monitoring promotions across a computer network.

In various embodiments, the following actions are enabled. 1. Create Promotion: A brand manager (at a firm producing products) or a category manager (at a retail firm selling products) specifies the promotion start/end date, the product to be promoted, the discount, the target audience, the store locations and the display locations within the store—all through a simple web browser-based interface. 2. Submit Promotion: A brand manager or category manager (promoter) hits the “submit” button on his browser, and the promotion is made available (via our software) for the retailer to review and approve. 3. Review/Approve Promotion: A retailer visits a web portal and reviews proposed promotions by category, by brand and by time. The retailer—for each promotion—decides either “yes” (run promotion), “no” (do not run promotion) or “make changes” (may run promotion if select changes are made). 4. Process/Target Promotion: commands are run on the software to conduct consumer targeting on the (approved) promotions. 5. Distribute Promotion Online: The targeted promotions are pushed to an application server which enables the promotions to be executed through an online store. Per other patents originally assigned to InformLink, this approach for issuing promotions online is novel. 6. Distribute Promotion Offline: Promotions are made redeemable electronically by pushing the content to a retailer's POS system. This enables the promotion to be redeemed simply by swiping a loyalty card. In order to notify the consumer about which promotions are available to him/her, a piece of email, direct mail, or the like is sent to the consumer. 7. Redeem Promotion: Promotions are redeemed online by clicking on the promotion in order to add it to the shopping cart. In order to receive the discount, the appropriate product must also be purchased in the same cart. Promotions are redeemed offline by swiping the loyalty card at the store and simultaneously purchasing the appropriate products. 8. Analyze Promotion: Purchase data from the stores is sent to a central server on a real-time basis, on a periodic basis, such as once-per-day, or the like, and we process that data in order to create a set of analytical reports. All promotion reports are accessible through a web portal whereby a brand manager issues a query for which reports he wishes to see, and then such reports are displayed on the screen.

In one embodiment, as on-line consumers browse through the aisles of an online or a brick-and-mortar store and decide what to put in their shopping cart, the system described below allows marketers to communicate with the consumers and impact their buying decisions. In particular, embodiments of the present invention provide help marketers offer various real-time promotions based on special targeting criteria. Accordingly, marketers can convey a variety of messages to a variety of target consumers at critical moments when the consumer is making choices. Such promotions benefit consumers, who receive valuable personalized content, and benefit online retailers or the like, who experience increased sales and site-loyalty.

Some embodiments of the present invention deliver real-time promotions. The assignee of the present invention provides Electronic Consumer Incentives™ (ECI™) brand real-time promotions to on-line customers as they shop. The real-time promotions are dynamically displayed on consumers' computer screens in an unobtrusive manner as consumers navigate though online stores making purchase decisions. Different real-time promotions are viewed by each consumer, depending on how consumers fit promotion targeting criteria specified by the promoter (marketers). In some embodiments, as a consumer places an item in her shopping cart or navigates to a different “aisle” or category in an on-line store, different real-time promotions will appear on her computer screen. One embodiment of this real-time promotion is implemented using products and services available from the current assignee: Computer Sciences Corporation.

Additional embodiments of the present invention package and provide custom promotions to customers who shop in brick-and-mortar stores. For example, consumers may receive incentives individually directed to them via interactive kiosk, wireless device (page, text message, etc.), audio message, and the like while shopping at a point of sale (POS) such as at a grocery store, etc. In other embodiments, consumers may receive notice of promotions, again individually directed to them, at home or work, via e-mail message, targeted mailing, phone call, and the like. In some embodiments, the promotions are typically delivered to customers by leveraging a store's Loyalty Program infrastructure. For example, if a store has a Loyalty Program infrastructure, such as a “Savings Club Card,” program or the like, promotions may be targeted and distributed to customers by referencing their loyalty program customer data. In some embodiments, direct mailings or other customer notification may be performed by other means. In some embodiments, the promotions may be targeted to customers based upon criteria set forth by on-line by promoters (manufacturers) by the stores, and the like. Such promotion criteria are then loaded into a store's loyalty program infrastructure and then the promotion is executed.

In the above embodiments, promotion analysis and feed-back can occur in near-real time.

For example, as will be described further below, promotion redemption data, and other aspects related to the promotion typically can be uploaded from the on-line customer server or from the loyalty program infrastructure, or the like. With this data, the promoter, or the like can quickly determine whether the promotion is reaching the desired target customers (tracing promotions), is being redeemed, and the like. In light of such data, a promoter can quickly modify the promotion on-line using the process described below. For example, the promoter can modify the target demographics or target customer profile, can change the amount of the promotion discount, can extend or expand the promotion to other target customers, on-line stores or other brick-and-mortar stores, and the like. By providing on-line promotion specification, on-line distribution, on-line redemption data, and on-line analysis embodiments of the present invention can truly be termed “paperless.”

According to one aspect of the present invention, a method for an integrated promotion system is disclosed. The method may include receiving a specification of a promotion in a central server from a promoter system coupled via a computer network, the specification of the promotion including a promotion identifier, and a customer targeting criteria, determining in the central server, a point of sale server destined for the promotion, in response to the customer targeting criteria, converting the specification of the promotion in the central server into a point of sale data packet appropriate for the point of sale server, and providing the point of sale data packet to the point of sale server via a computer network. Techniques may also include providing notice of a promotion to a first targeted customer in the point of sale server in response to the point of sale data packet, providing a promotion benefit to the first targeted customer when the first targeted customer meets preconditions of the promotion, storing in the point of sale server, transaction data of the first targeted customer, when the first targeted customer meets the preconditions of the promotion, and uploading the transaction data of the first targeted customer to the central server via a computer network. The promotion report in the central server is then generated, in response to the transaction data of the first targeted customer, and the promotion report is then provided to the promoter system via a computer network.

According to another aspect of the present invention, an integrated promotion system is described. The system includes a data server configured to receive a specification of a promotion from a promoter system via a computer network, wherein the specification of the promotion including promotion targeting criteria, wherein the data server is configured to determine a point of sale system where the promotion is to be sent in response to the specification of the promotion, and wherein the data server is configured to form a promotion data packet compatible with the point of sale system, and a point of sale server coupled to the data server configured to receive the promotion data packet from the data server via a computer network, wherein the point of sale server is configured to implement the promotion in response to the promotion data packet, configured to direct notification of the promotion to a first targeted customer, configured to provide a promotion benefit to the first targeted customer when the first targeted customer fulfills preconditions of the promotion; and configured to store promotion fulfillment data. The data server is typically configured to receive the promotion fulfillment data from the point of sale server, configured to process the promotion fulfillment data; and configured to allow the promoter system to view the promotion fulfillment data via a computer network.

According to yet another aspect of the present invention, a method for a promotion is described. In one system, the method includes receiving a specification of a promotion in a central server from a promoter system coupled via a computer network, the specification of the promotion including targeting criteria, and determining in the central server servers where the promotion will be distributed to in response to the targeting criteria, the servers including a loyalty card server and an application server. The method may also include formatting the promotion into a first data packet appropriate for the loyalty card server, formatting the promotion into a second data packet appropriate for the application server, providing the first data packet to the point of sale server via a computer network, and providing the second data packet to the application server via a computer network. Remotely, the process may include providing notice of the promotion to a first targeted customer in the loyalty card server in response to the first data packet, providing a promotion benefit to the first targeted customer when the first targeted customer meets preconditions of the promotion, storing in the loyalty card server, transaction data associated with the first targeted customer, when the first targeted customer meets the preconditions of the promotion, providing notice of the promotion to a second targeted customer in a merchant server coupled to the application server in response to the second data packet, and storing in the application server, promotion impression data associated with the second targeted customer, when the second targeted customer is presented with a description of the promotion. Additionally, remote systems may also perform the steps of uploading the transaction data associated with the first targeted customer to the central server via a computer network, and uploading the promotion impression data associated with the second targeted customer to the central server via a computer network. A process may also include generating a promotion report in the central server, in response to the transaction data of the first targeted customer and in response to the promotion impression data associated with the second targeted customer, and providing the promotion report to the promoter system via a computer network.

### BRIEF DESCRIPTION OF THE DRAWINGS

In order to more fully understand the present invention, reference is made to the accompanying drawings. Understanding that these drawings are not to be considered limitations in the scope of the invention, the presently preferred embodiments and the presently understood best mode of the invention are described with additional detail through use of the accompanying drawings in which:

FIG. 1 illustrates a block diagram according to an embodiment of the present invention;

FIG. 2 is a block diagram of typical computer system 200 according to embodiments of the present invention;

FIG. 3 illustrates a block diagram according to an embodiment of the present invention;

FIGS. 4A-B illustrate logical diagrams according to an embodiment of the present invention; and

FIGS. 5A-E illustrate a block diagram of a flow chart according to an embodiment of the present invention.

### DESCRIPTION OF THE SPECIFIC EMBODIMENTS

The following terms are used in the present application:

Brand—A specific group of related products.

Category—Hierarchical product association, (e.g. Disposal Diapers).

Category ID/Listing—A number assigned to a category.

Category Structure—also called Product Categorization or (sometimes it is also used as Product Classification). A fat-tree structure (acyclic DAG) that defines a parent-child category relationship as well as a set of product identifiers and sub categories. Each node of the tree is a category (node). If a category has child categories, it is also called a supercategory or parent category of the child category. If a category has parent category it is also called subcategory of its parent category. A category can have multiple parent categories. A category without child is called a leaf category, which corresponds to a leaf node in a tree structure. Typically, a product identifier is associated to the leaf category. But non-leaf category can also be associated to product identifiers along with other subcategories. It should be understood that the term “tree,” “tree structure” or the like, used herein refers to many possible types of trees that can be used in the embodiments of the present invention, such as a fat-tree structure, and the like.

Cents Off—Cents off promotions are used for giving a specific dollar amount of a product or groups of products. Example: Buy any widget get $0.50 off or buy any widget and any trinket save $1.00. More generally, such promotions describe an amount of monetary savings available.

Creation Date—The date the promotion was created.

Cycle—A defined period of time that a promotion can run. In one embodiment, there are 13 cycles a year and manufacturers/promoters have the ability to run promotions in a certain category per cycle.

Description—Description for the promotion. Example: Any 12-oz. Soft Drink.

Display Types—A display type is selected when the promoter determines how a promotion should be displayed on a customer display. Display types include static and trigger. A static display is delivered in a specific aisle of the store (in cases where systems exist to dynamically present consumers with marketing content in the physical or online store). A triggered display is delivered from a current shopping pattern of a customer or based upon items within a current customer cart (again, in cases where systems exist to present this content to consumers).

Division—Hierarchical reporting level inside a Company that is used for grouping brands together.

Effective Date—The date the promotion begins.

Electronic Consumer Incentives™ (ECI™)—Computer Sciences Corporation's brand real-time promotions delivered to customers as they shop.

Expiration Date—The date the promotion ends.

Free Value—Free Value is used for running a ‘Buy X, Get Y Free” promotion, or for giving away a free sample. Example: Buy one widget get one free, buy widget A get widget B free.

Name—The Brand Manager's, Promoter's, Manufacturer's name.

Offer Description—A description of the promotion/offer.

Offer Setup—Detailed rules the promoter enters to define the offer.

Offer Tracking Code—A unique number assigned by the Brand Manager or Retailer. This code becomes the permanent identifying number that is used for all future queries, tracking and reporting. In one embodiment the field can be 10 characters.

Offer Type—An offer type is the type of offer the product wants to execute.

Participating Retailers—Retailers or Merchants that will display the promotion.

Price Point—Price Points are used to promote an item or items at a certain price. Example: Buy any widget for $2.99.

Product UPC—A universal product code that uniquely identifies and defines each product.

Program Manager—A Program Number is used to group a set of promotions together. An example would be a campaign using multiple promotions for a common theme. The program number allows the promoter to receive reports of all promotion activity for a campaign under a master number.

Promotional Content—Used for displaying recipes or product information. This can be used alone or in conjunction with another offer type. Embodiments require a link to a URL that will contain the text copy, however content may also be maintained locally.

Restriction—Limitations of the promotion. Example: Limit one per customer.

Title—Title or name of the promotion. Example: Save $2.00.

Promotional Content URL—Retailer's website address.

UPID—UPID (Universal Promoter Identification) is selected from a list or entered manually—An invoice number that is used by the central data server to track promotions created by marketers (promoters).

User ID—An ID that identifies the user (e.g. brand manager/promoter, retailer/merchant).

User Name—Name of the assigned user, brand manager or retailer.

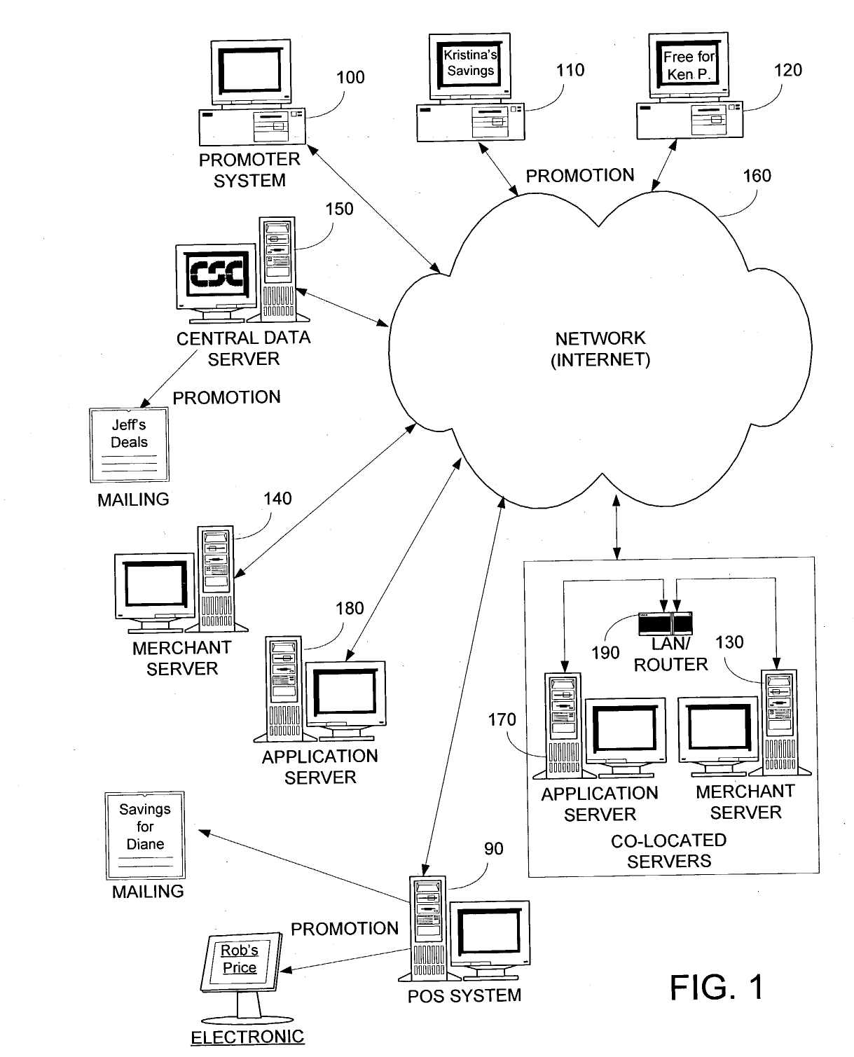

FIG. 1 illustrates a block diagram according to an embodiment of the present invention. FIG. 1 illustrates a loyalty card system 90, a promoter system 100, client systems 110 and 120, merchant servers 130 and 140, and a central data server 150 coupled to a computer network 160. Merchant server 130 is coupled to an application server 170, and Merchant server 140 is coupled to an application server 180.

In the present embodiment, promoter system 100 and client systems 110-120 are standard personal computers used by business, individuals, and the like. Client systems 110-120 are used by users to communicate with merchant servers 130 and/or 140. In the present example, promoter system 100 and client systems 110-120 typically use web browser programs, and other software, as will be described further below.

Promoter system 100 and client systems 110-120 are typically connected to computer network 160 via dial-up, ISDN, DSL, cable, satellite modems or the like, via wireless network interface hardware, or the like. Merchant servers 130 and 140, and data server 150 are typically connected to computer network 160 through high bandwidth channels, such as T1 or T3. Further, local area networks and routers (LANs) may also be used by client systems 100-120, merchant servers 130 and 140 and/or data server 150.

In this example, merchant servers 130 and 140 are typically web servers and/or gateway servers. Such servers may or may not be physically resident on the merchants property. As web servers, merchant servers 130 and 140 are typically used to host the merchant's web site including storage of web pages, a database, and the like.

Coupled to merchant servers 130 and 140 are application servers 170 and 180, respectively. In one embodiment, application server 170 is coupled to merchant server 130 via a LAN 190, or the like. In such an embodiment, application server 170 and merchant server 130 may be co-located at the same server facility. Advantages to co-location include that communication between merchant server 130 and application server 170 is enhanced and server response latencies are greatly reduced.

In another embodiment, application server 180 is coupled to merchant server 140 via computer network 160. In this embodiment, communication between these servers may be via a virtual private network (VPN), or other secure protocol, such as an SSL or S-HTTP. In still other embodiments, application server 180 may provide services to more than one merchant server. For example, application server 180 may provide services to merchant server 140, to merchant server 130 as a back-up for application server 170, and for other merchant servers that do not have a co-located application server.

Loyalty card system 90 is typically a system that implements a loyalty card system. Examples of implementations of such systems include an “Albertson Preferred Card,” “Safeway Club Card,” and the like. In embodiments of the present invention, loyalty card system 90 include point of sale (POS) systems from IBM (Electronic Marketing Application), NCR, Hitachi, or any other off-the-shelf or custom system that may implement loyalty card functionality. In the present embodiments, loyalty card system 90 may be coupled to central data server 150 via computer network 160 using conventional techniques such as dial-up, ISDN, DSL, cable, satellite modems or the like, via wireless network interface hardware, or the like. High bandwidth channels, such as T1 or T3 may also be used.

Promoter system 100 is typically coupled to data server 150 via computer network 160. In other embodiments, other types of communications channels may be used, such as direct dialup, or the like. In this embodiment, promoter system 100 is used by a user to specify parameters of a real-time promotion (or electronic incentive) to be stored and implemented in data server 150, as will be described further below. In the present embodiment, data server 150 may include a web server application that communicates with promoter system 100.

In the present embodiment, data server 150 provides promotion data to application servers 170 and 180 and to loyalty card system 90 via computer network 160. Additionally, data server 150 receives return data from application servers 170 and 180 and loyalty card system 90 via computer network 160. More specifically, as will be discussed below, data server 150 “packages” the real-time promotion parameters received from promoter system 100 and provides promotion data to application servers 170 and 180 and/or to loyalty card system 90. In return, application servers 170 and 180 and/or loyalty card system 90 provide promotion usage data back to data server 150. In other embodiments, other forms of communications channels may be used between the servers 150 and 170, 180, and 90, such as direct dial-up connections, rf, satellite, and other wireless communications schemes, and the like.

Computer network 160 is typically a wide area network (WAN) such as the Internet, or the like. In this embodiment, computer network 160 may use communication protocols such as TCP/IP, RTP, RTSP, or the like for the transfer of data. In other embodiments, computer network 160 may be a local area network (LAN), based upon TCP/IP, IPX, or the like. As mentioned above, computer network 160 provides data communication among systems 100-120, servers 130-140, 170, and 180, and other computer servers and systems. Data communication may include transfer of HTML based data, textual data, form submissions, plug-in programs or viewers, applets, packetized audio or video data, real-time streaming data, and the like. Although computer network 160 is illustrated as a single entity, as is the case with the Internet, it should be understood that computer network 160 may actually be a network of individual computers and servers.

The diagram in FIG. 1 is merely an illustration which should not limit the scope of the claims herein. One of ordinary skill in the art would recognize many other variations, modifications, and alternatives.

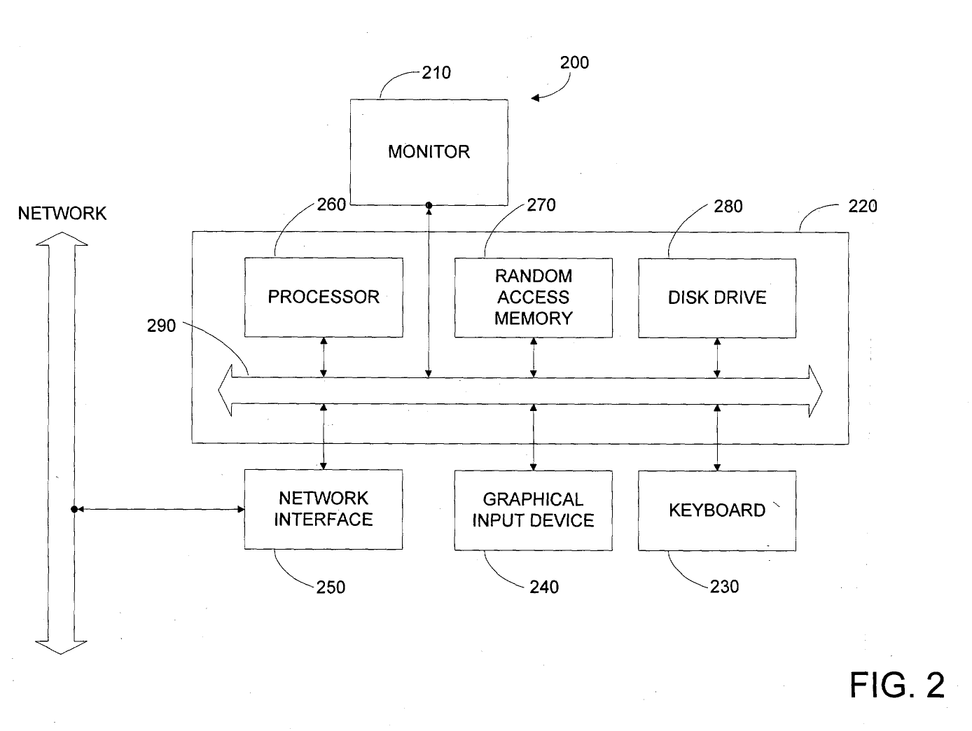

FIG. 2 is a block diagram of typical computer system 200 according to embodiments of the present invention. Embodiments of systems 100-120 and servers 130-140, 170, 180, and 90 may be embodied as computer system 200.

In the present embodiment, computer system 200 typically includes a monitor 210, computer 220, a keyboard 230, a user input device 240, a network interface 250, and the like.

In the present embodiment, user input device 240 is typically embodied as a computer mouse, a trackball, a track pad, wireless remote, and the like. User input device 240 typically allows a user to select objects, icons, text and the like that appear on the monitor 210.

Embodiments of network interface 250 typically include an Ethernet card, a modem (telephone, satellite, cable, ISDN), (asynchronous) digital subscriber line (DSL) unit, and the like. Network interface 250 are typically coupled to a computer network as shown. In other embodiments, network interface 250 may be physically integrated on the motherboard of computer 220, may be a software program, such as soft DSL, or the like.

Computer 220 typically includes familiar computer components such as a processor 260, and memory storage devices, such as a random access memory (RAM) 270, disk drives 280, and system bus 290 interconnecting the above components.

In one embodiment, computer 220 is a PC compatible computer having an x86 based microprocessor, such as an AthlonXP® or an Athlon® microprocessor from Advanced Micro Devices, Inc. Further, in the present embodiment, computer 220 typically includes a Windows® operating system such as WindowsXP®, Windows MEW, WindowsNT®, or the like from Microsoft Corporation.

RAM 270 and disk drive 280 are examples of tangible media for storage of data, audio/video files, computer programs, browser software, embodiments of the herein described invention, applet interpreters or compilers, virtual machines, web pages, databases such as Oracle 9i, decision support system (DSS) software from companies such as MicroStrategy, and the like. Other types of tangible media include floppy disks, removable hard disks, optical storage media such as CD-ROMS and bar codes, semiconductor memories such as flash memories, read-only-memories (ROMS), battery-backed volatile memories, and the like. In embodiments of the present invention, such as set top boxes, mass storage, such as disk drive 280, and the like may be dispensed with.

In the present embodiment, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 2 is representative of types of computer systems for embodying the present invention. It will be readily apparent to one of ordinary skill in the art that many other hardware and software configurations are suitable for use with the present invention. For example, other types of processors are contemplated, such as Pentium™ class, Celeron™-class, or other microprocessors from Intel Corporation; PowerPC G3™, G4™ microprocessors from Motorola, Inc.; Crusoe™ microprocessors from Transmeta, and the like. Further, other types of operating systems are contemplated, such as Solaris, LINUX, UNIX, MAC OS from Apple Computer Corporation, and the like. Additionally the specific configuration of the hardware and software will vary when computer system 200 is configured as client system 110, as promotion server 150, or the like. In still other embodiments, set top boxes such as the PS2, X-Box, WebTV, and the like may also be used.

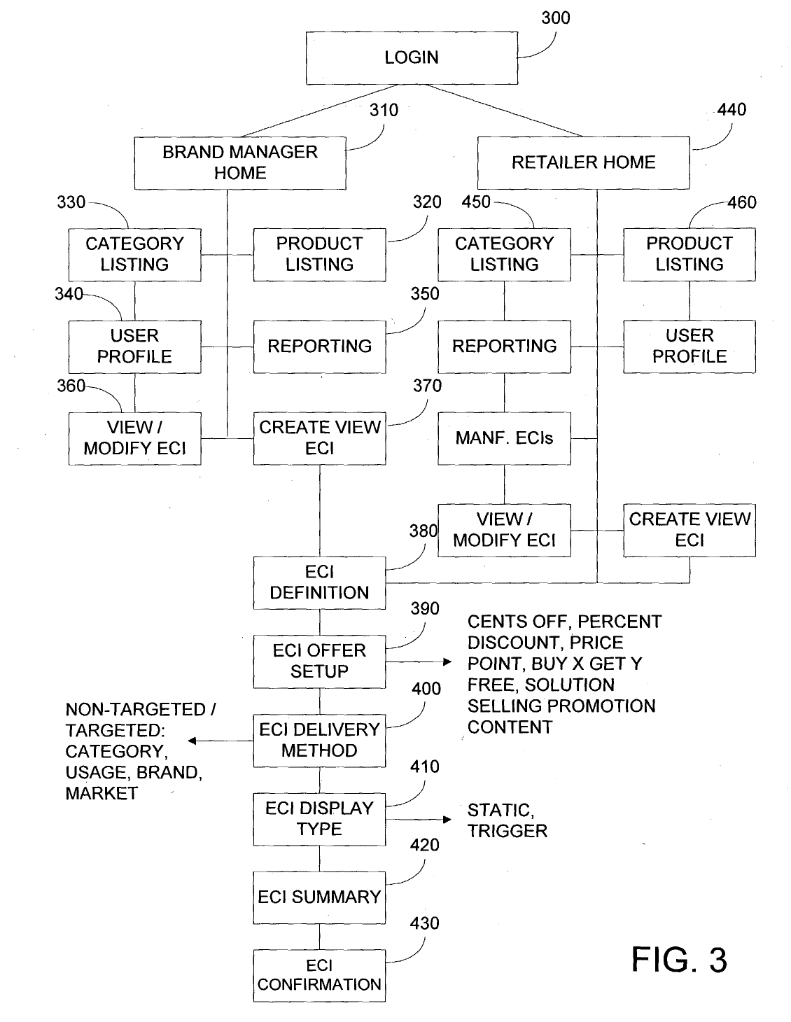

FIG. 3 illustrates a block diagram according to an embodiment of the present invention. In particular, FIG. 3 illustrates the logical software architecture of centralized data server 150. In this embodiment, users (promoters) at promotion server 100 and users (merchants) at merchant servers 130 can specify and/or view real-time promotions and data related to promotions.

In FIG. 3, a login process 300 is provided that authenticates and verifies the user. In this case, promoters and merchants are typically pre-assigned accounts with data server 150 after agreeing to the real-time promotion service. In other embodiments, such users can sign-up online.

When the user is identified as a promoter, the user is directed to the brand manager home 310. From there, the promoter is given a variety of options. For example, the promoter can define and view products available for promotional activity with a product listing process 320. The promoter can also define and view categories of product available for promotional activity with a category listing process 330, e.g. a product/service categorization scheme. In process 340, the user can define and change the promoter profile, for example, brand manager name, contact information, and the like.

In reporting process 350, the promoter can review report data representing executed promotions, active promotions, and the like. In one embodiment, the report data includes which promotions were used by consumers, the demographics of the consumer, the number of promotion impressions, the items purchased, or the like along with the promotion, and the like. In additional embodiments, other types of data that may be provided include the amount of promotion provided, category views, trigger views, and the like, as will be described further below. Such data is useful to the promoter in determining the success of different promotions, different promotion strategies, the success of promotion targeting, and the like.

Process 360 allows the promoter to view and modify the various parameters of promotions that are created in processes 370-420. In other embodiments of the present embodiment, DSS software from MicroStrategy, or the like, may provide analysis tools such as OLAP tools on the transactional data.

In the present embodiment, processes 370 and 380 allow the promoter to create and define a promotion. Process 380 includes sub-processes 390-430. In the present embodiment, sub-process 380 allows the promoter to setup administrative details of the promotion. In this example, the promoter may specify an offer tracking code, a program number for the promotion (e.g. to identify a “back to school” promotional campaign), a timing cycle, and merchants or retailers that will participate in the promotion. In other embodiments, additional administrative details may be specified including a phenotype of the promotion, a description of the promotion, promotional limitations, effective date, expiration date, a URL including additional promotional content (e.g. a web-site including recipes), and the like.

In this embodiment, sub-process 390 allows the promoter to specify the actual promotion. The promotion typically includes an offer type, a product bundle, and an amount. In this example, typical offer types includes cents off, percent discount, price point, buy X get Y free, free value (e.g. product samples), additional promotional content, and the like.

In still other embodiments, promoters can offer exclusive promotions according to product category level and/or customer level. In other words, one or more promoters may specify, for example, that only one of three promotions are to be directed to customers. As an example, the promotions may be promotions from Pepsi, Coca Cola, and 7-Up for products, however, only a Coca-Cola drinker will receive the 7-Up promotion, a 7-Up drinker will receive the Pepsi promotion, and a Pepsi drinker will receive the Coca Cola promotion. As another example, one or more promoters may specify exclusive offers such as frequent buyers of hot dog buns receive promotions for Heinz Ketchup, and frequent buyers of hamburger buns receive promotions for Hunt's Ketchup.

A product bundle typically refers to products that must be purchased together in order to trigger the promotion. For example, a bundle may include purchase of ketchup, mustard, and relish. In this embodiment, the product bundle may include up to three products, although in other embodiments, a greater number of products may be bundled.

In this example, the number of times a specific promotion may be used can be specified by the promoter. For example, the maximum number of promotion uses may be limited by the total number per merchant/retailer, the total number for the promotional campaign, and/or the number of promotion uses per shopping trip (e.g. one per visit). Additionally, the maximum number of dollars used in the campaign may be specified, and the like. These limitations to the number of times a promotion may be used may be specified for each of the offer types discussed above.

In this embodiment, sub-process 400 allows the promoter to specify a delivery method for the promotion. In particular, this process allows the promoter to target the promotion. In this example, four types of targeting methods are provided: category, usage, brand, and market. Category targeting targets promotions based upon consumer consumption of products within that category; usage targeting targets promotions based upon consumer consumption of specific product; brand targeting targets promotions based upon a percentage of purchases of a specific brand; and market targeting targets markets based upon geography. Additional types of targeting methods include: targeting customers based upon customer loyalty to specific products, based upon total dollar amount or buying percentage; based upon customer loyalty to shopping in certain categories, based upon dollars or buying percentage; based upon customer shopping frequency; a sample group, for promotional research; based upon customer shopping cart size (e.g. maximum, minimum, average); and the like. In other embodiments, other types of promotion targeting may include targeting based upon demographic data, income; the promotions may also target specific customers or different retailers; and the like. In other embodiments, targeting may be combined with any of the above types of offers.

Sub-process 410, in FIG. 3, allows the promoter to specify a promotion display type. Sub-process 410 is particularly relevant to on-line shopping, but may also be used with in-store POS systems. This process allows the promoter select between static or triggered display. In this example, static display is when the promotion is displayed to a consumer in a specific “aisle” or category in the store. Further, triggered display is when the promotion is displayed in response to particular actions of the consumer. For example, when the consumer has placed particular items in her shopping cart, when the consumer shopping patterns have met certain constraints, and the like.

Sub-processes 420 and 430 allow the promoter to preview the specified promotion and confirm the promotion. As will be described below, after confirmation of the promotion is received in data server 150, data server 150 distributes the promotion to the application servers associated with merchant servers specified by the promoter.

In FIG. 3, if the user is identified as a retailer, the user is directed to the retail manager home 440. From there, the retailer, such as an on-line grocery store, an on-line commerce site, or a brick-and-mortar store, is given a variety of options similar to the promoter or brand manager. Importantly, the retailer can define and view their own categories of goods or services offered with process 450, e.g. a product/service categorization scheme, and populate the categories with products with process 460. This may be different from the promoter category listing 330. Other processes are also available to the retailer as illustrated.

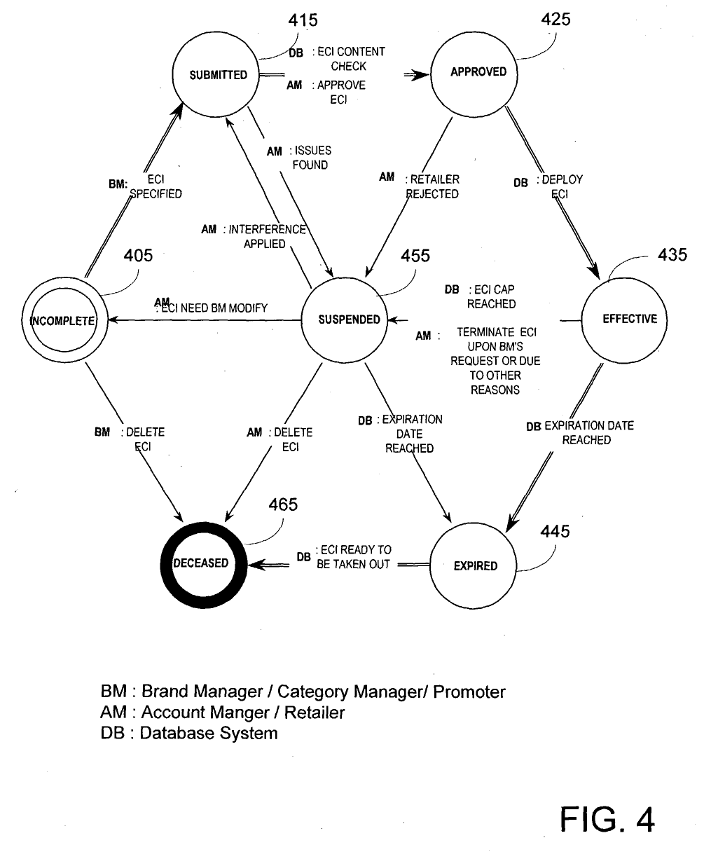

FIGS. 4A-B illustrate logical diagrams according to an embodiment of the present invention. In particular, FIG. 4 illustrates a logical state diagram of a promotion within centralized data server 150.

In state 405 a promoter at promotion server 100 defines and prepares a promotion. After preparation, the promotion is submitted for approval and distribution, state 415. From state 415, if the promotion is approved for distribution, the promotion state moves to state 420.

In this embodiment, promotions have an effective date and an expiration date. After the approval state, when the effective date of the promotion is reached, the state machine moves to state 435. In this state, the promotion is propagated to one or more application servers 170 and/or to loyalty card system 90. The state machine then moves to state 445, when the expiration date of the promotion is reached, and the state machine moves to step 465, and the promotion is disabled.

From states 415, 425, or 435, the promotion may be suspended. In such cases, the state machine moves to state 455. From state 455, the promotion may be modified or disabled. When the promotion is to be modified, the state machine moves back to state 405, and if the promotion is disabled, the state machine moves to state 465.

FIG. 4B illustrates a logical flow diagram of a promotion creation, distribution, redemption, and analysis. In particular, FIG. 4B illustrates a series of logical phases including a promotion creation phase 470, a promotion approval phase 475, a promotion processing phase 480, a promotion distribution phase 485, a promotion redemption phase 490, and a promotion analysis phase 495. Each of these phases will be described in greater detail below.

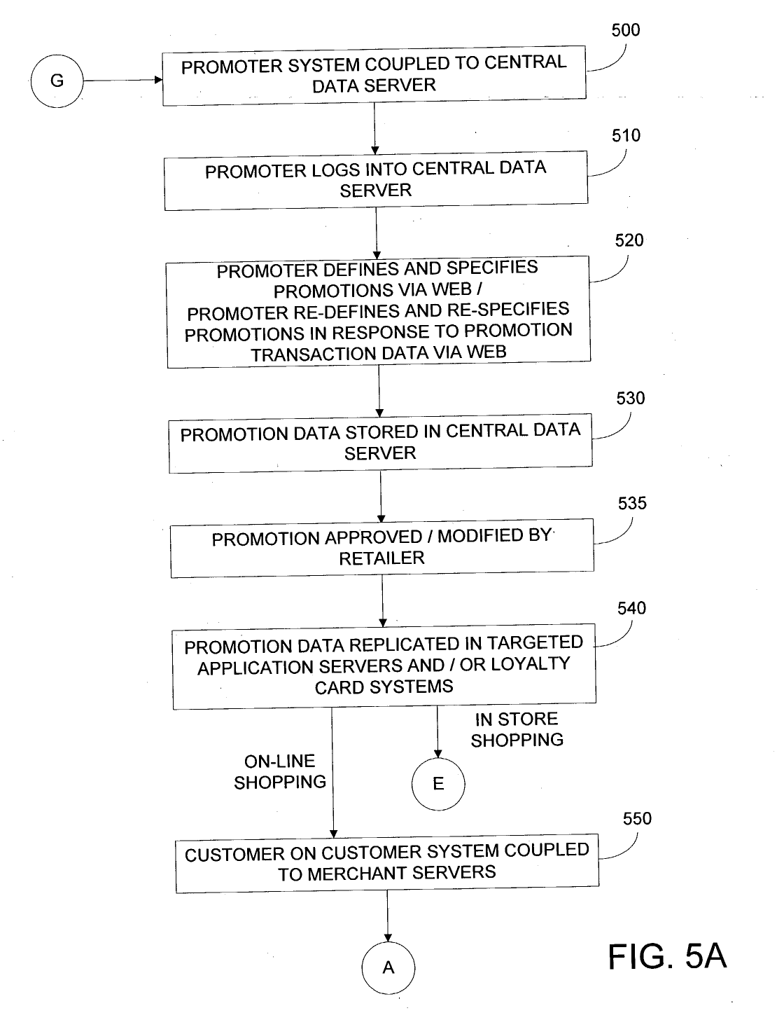

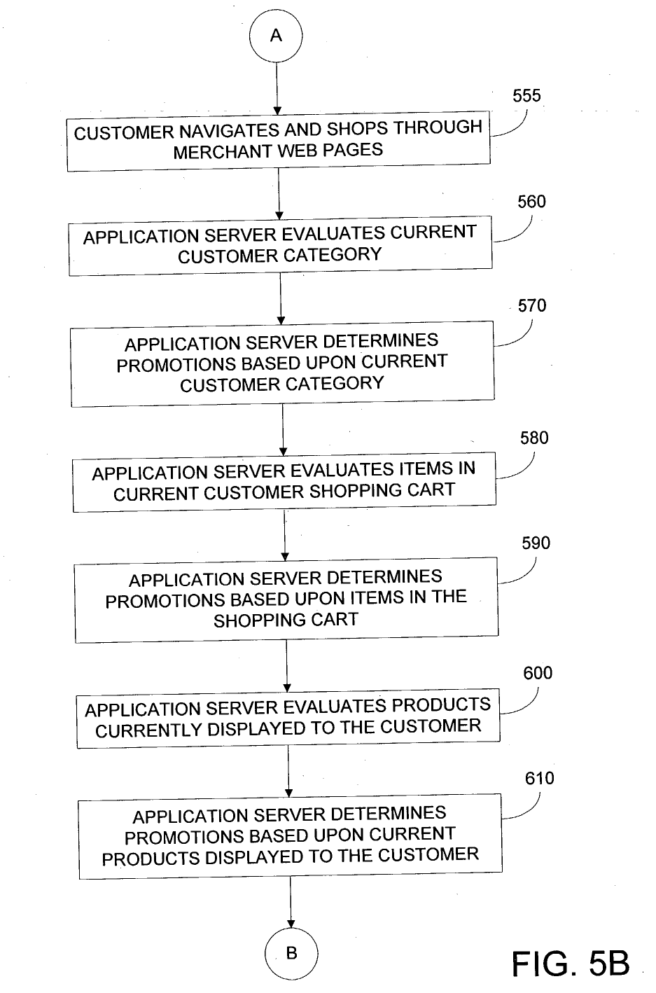

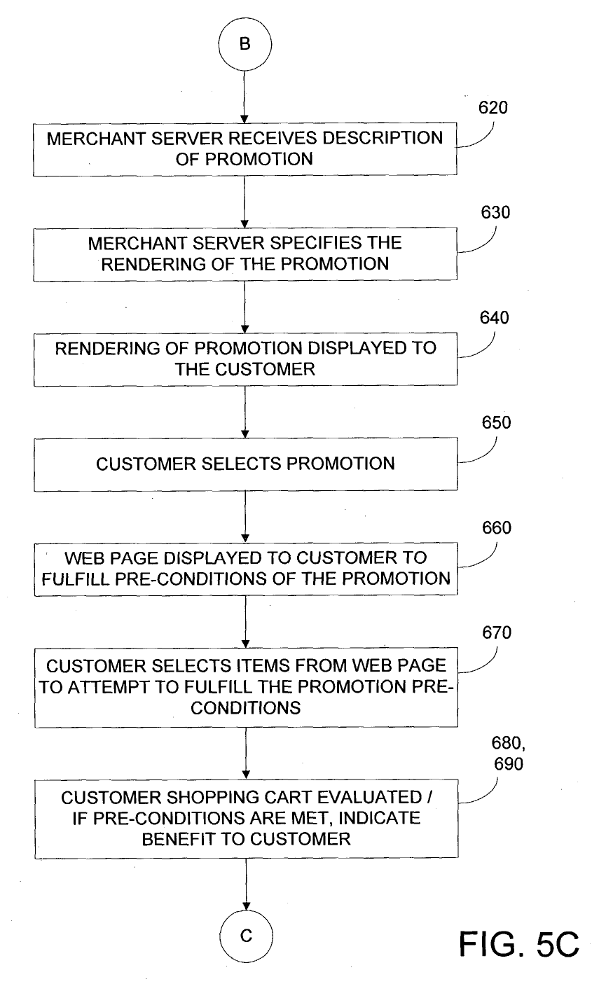

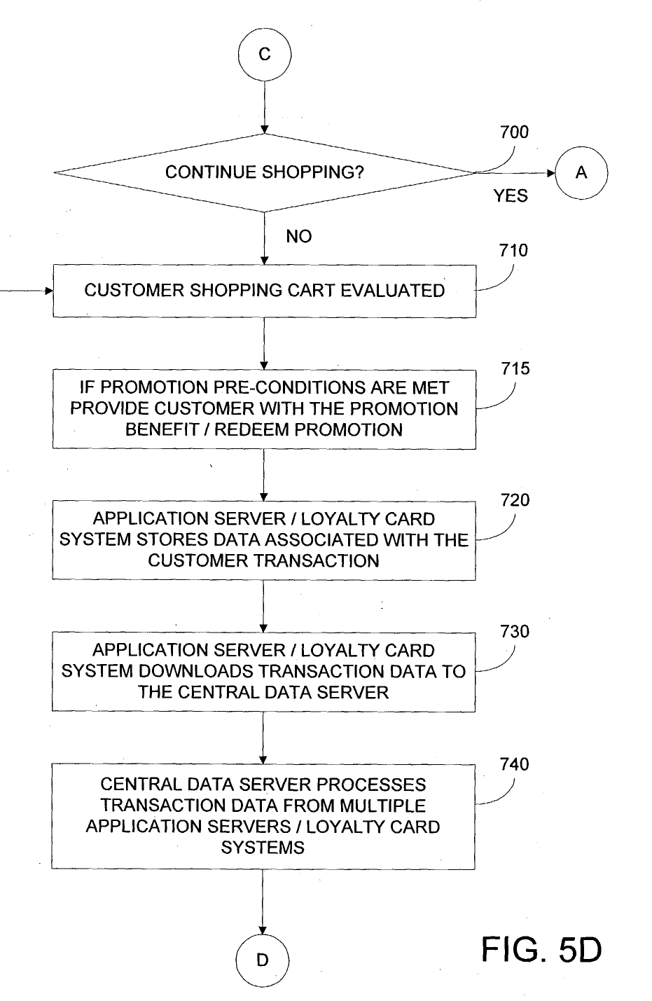

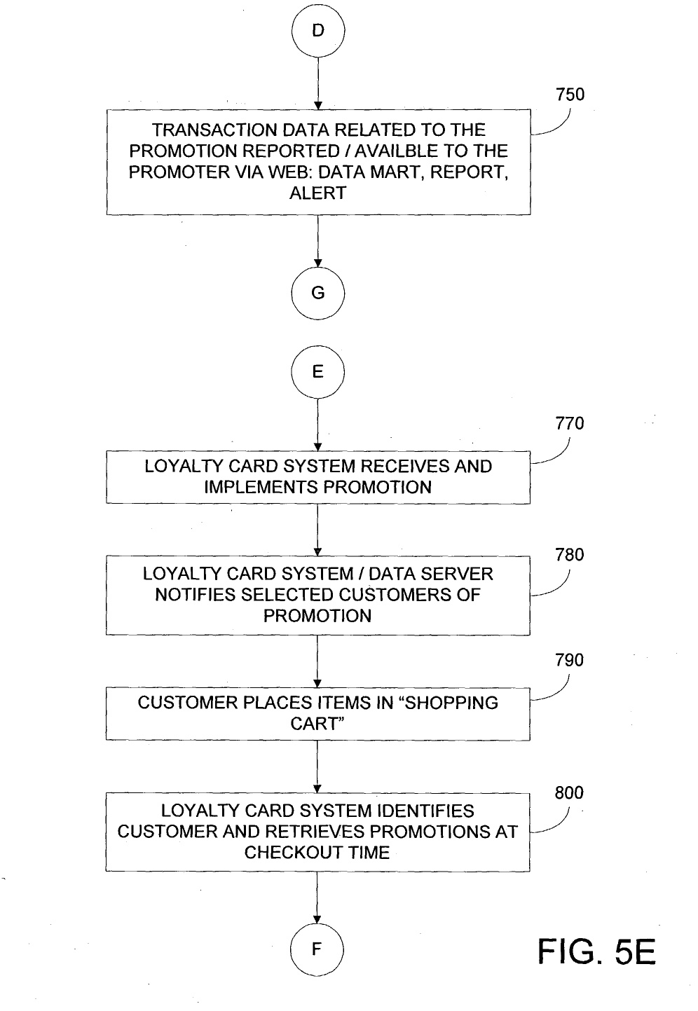

FIGS. 5A-E illustrate a block diagram of a flow chart according to an embodiment of the present invention. In particular, FIGS. 5A-E illustrate the process of defining, using, and reporting usage of a promotion with reference to the elements in FIG. 1.

Initially, a user (promoter) at promoter system 100 (or a merchant system) is coupled to central data server 150, step 500. In one embodiment of the invention, promoter system 100 is coupled to data server 150 via computer network 160. In such embodiments, conventional network protocols may be used such as TCP/IP, IPX, and the like. Other types of networks such as VPN or wireless networks may also be used. In other embodiments, promoter system 100 may be coupled to data server 150 through other direct means such as dial-up lines, wireless connections, dedicated connections and the like. In one embodiment, promoter system 100 uses a web browser to request and retrieve a web page hosted by data server 150.

Once coupled to data server 150, the promoter at promoter system 100 typically logs into their account, step 510. The login process may include the promoter entering their user name and password, PIN, or the like on a Web form.

After successfully logging, in the promoter creates and defines the promotion, step 520. As described above in FIG. 3, various software processes with data server 150 allows the promoter to define the promotion type, delivery method, display type, and the like. The data is typically entered via a series of web form and submissions. In this embodiment, the promotion is stored within data server 150, step 530. Data structures used by data server 150 for storage of the promotion data, and other related data was discussed above.

In one embodiment of the present invention, the retailer may log into data server 150 in the same manner described above. The retailer may review and approve promotions submitted by promoters, step 535. In addition, the retailer may also make some changes to the promotion, and then approve the changed promotion.

In the present embodiment, the promotion is then distributed to application servers, such as application server 180, or to a POS system, such as loyalty card system 90, step 540. In one embodiment, promotions are distributed to all application servers and/or to all POS systems. In another embodiment, the promotion may only specify that the promotion is distributed to only application servers coupled to particular merchant servers, such as only Safeway.com and/or to only specific POS systems, such as only Albertson's stores. In alternative embodiments, promotions are not limited to distribution to certain application servers and promotions may be distributed to all application servers and all loyalty card systems. Accordingly, the process allows a promoter to simultaneously specify a promotion for the on-line world and the brick-and-mortar world at the same time, and such promotions may be distributed to virtually all known methods for promotion distribution.

In some embodiments of the present invention, a promoter may specify a limited sampling size and a targeted group, accordingly, the promotion is not automatically distributed to all target systems. In such embodiments, data server 150 may select which on-line and/or which brick-and-mortar stores to target, based upon historical data collected by data server 150.

In some embodiments where a on-line or a brick-and-mortar store specify a maximum or limited number of promotions, data server 150 may prioritize and limit the promotions. For example, an on-line store may state that only five promotions are to be active per day. In such a case if data server 150 receives ten promotions for on-line stores from promoters, data server 150 will pick the top five promotions for distribution to the on-line store. In another embodiment, data server 150 may implement promotion exclusivity, to thus

In this embodiment, the data entered by the promoter is packaged within a data structure, (i.e. a set of promotion data) and downloaded to an application server. Currently, different commercially available POS systems have different data structures and formats for defining or specifying promotions. Accordingly, in the present embodiment, data server 150, or other server, will format promotions specific to the targeted POS system. In either situation, it is envisioned that the promotion data is typically small, on the order of hundreds of bytes of data.

For promotions sent to on-line shopping systems, the method may continue with step 550, and for promotions sent to POS systems, the method may continue with step 770. Additionally, for promotions sent to both systems, the steps beginning with step 550—and step 770—may be initiated and executed in parallel or at different times.

For on-line shopping systems, in the present embodiment, an application server typically receives one or more sets of promotion data, each representing a promotion from data server 150. Data from the set of promotion data is then used to populate data structures within the application server. The merchant server communicates with the application server through use of these data structures, for example, merchant server 140 and application server 180 communicate promotion data, and other data via use of the data structures discussed below.

In the current embodiment, the data structures typically comprise Microsoft COM software objects and object-oriented software programming techniques. In the current embodiment, software objects include: Service objects, promotion objects (sometimes termed “Coupon Objects” in the materials incorporated by reference), and Product objects. In other embodiments, additional objects may also be used.

In the present example, the merchant server invokes methods within Service objects to query the application server for promotions or to use such promotions. As an example, the merchant server “queries” the application server for promotions or to use the promotions, depending upon data specified by the merchant server. For example, the merchant server may first specify a shopping aisle/category that the consumer is currently browsing, may specify the current items in the consumer's shopping cart, may specify particular products that are presented to the consumer, and the like. In these embodiment, the merchant server may provide such data to the application server by requesting that particular Product objects be instantiated, as described below.

In this example, each Product object instantiated is used to represent an item within a consumer's shopping cart, or the like. A Product object contains a number of Product objects. In this embodiment, Product objects may include an item's UPC code, or the like.

In response to the invocation of methods within the Service objects, and to the instantiation of Product objects, the application server instantiates promotion objects. In particular, the application server uses the promotional data received from data server 150 and data represented by the Product objects to determine which promotions to display to the user. In this embodiment, the application server instantiates promotion objects and populates them with the promotions selected for display.

After the promotion objects have been instantiated by the application server, the merchant server displays the promotion on the display. In this embodiment, the merchant server calls methods of the instantiated Objects to retrieve a description of the promotion. Based upon the description, the merchant server renders a representation of the promotion for display on the customer's system. In the case where a promotion is to be used, a Service object method provides the net savings amount of the promotions used by the customer.

In the present embodiment, the customer and merchant servers are typically given a textual description of the pre-condition and benefit, e.g. “Macaroni and Cheese, 8 oz, $0.49.” No direct communication between the application server or customer takes place. If the consumer wishes to receive the benefit specified in the promotion, their actions are effected by the merchant server, and these actions are passed to the application server. The actions must satisfy the pre-condition in the application server before the benefit is provided. In particular, once the application server determines the pre-conditions are met, as discussed above, the application server provides the merchant server the benefit on behalf of the consumer, e.g. a credit of $0.49.

Further details regarding the objects within application server and the interaction of the merchant server and the application server may be found in the above referenced provisional applications.

The promotions typically specify a customer pre-condition and a customer benefit, e.g. buy the product and get a discount; buy two products, get a third one free; buy a product and get a free music CD. These promotions are not considered “coupons” as “coupons” is understood in the industry. More specifically, in the industry, “coupons” are typically defined as detachable certificates, tickets, or the like that entitle the bearer or holder to a benefit. In the present embodiment, the customer and the merchant server are not given any such detachable and/or possessable certificate and cannot hold, bear, or present anything.

By way of contrast, in one electronic couponing systems, a electronic coupon describing a right or benefit is created in a couponing server. The electronic coupon, or token, is then downloaded to a customer's computer system and stored. These coupons or tokens may be in the form of a cookie or the like stored on the customer's computer system. Much later, the customer may enter an electronic store that is independent of the electronic couponing system. Next, the cookie or token stored on the customer's computer system is retrieved and passed back to the electronic store web server. Because the customer's computer had “possession” of the cookie or token in the computer memory, the electronic store web server provides the customer the right or benefit or the bargain described, i.e. the customer is entitled to a 10% discount. This example thus illustrates that the electronic cookie or token incorporates the standard “coupon” model: the customer's computer memory stored the cookie, and possession of the cookie was a condition for receiving the bargain.

In the present embodiment, a customer on client system 110 is coupled to a merchant server, such as merchant server 140, step 550. In the present embodiment, it is envisioned that merchant system 550 is an on-line store selling goods and/or services. In one embodiment, the on-line store categorizes products in different aisles or categories, e.g. bakery items, snack foods, home loans, mystery books, legal services, and the like. In the present embodiment, client system 110 typically uses a web browser to communicate with merchant server 140 and to display data provided by merchant server 140. Next, the customer typically navigates through the different web pages provided by the merchant server and selects one or more items to put in a shopping cart, or the like, step 555.

In this example, as the customer shops around, the merchant server invokes a Service object within the application server to evaluate the customer's shopping category to determine if there any coupons to display, step 560. In response to the current shopping category, the application server determines whether any promotions are applicable and if so, one or more promotion objects are instantiated, step 570.

Additionally, the merchant server may also invoke a Service object within the application server to evaluate the items in the customer's shopping cart to determine if there are any coupons to display, step 580. In response to the items in the current shopping cart, the application server determines whether any promotions are applicable for the customer, and if so, one or more promotion objects are instantiated, step 590.

Further, the merchant server may also invoke a Service object within the application server to evaluate the products currently displayed to the customer to determine if there are any coupons to display, step 600. In response to the products displayed, the application server determines whether any promotions are applicable for the customer, and if so, one or more promotion objects are also instantiated, step 610.

Next, merchant server 140 queries one or more promotion objects that have been instantiated for a description of the pre-conditions and benefit, a image of the product, and the like, step 620. In response, merchant server 140 specifies the rendering of the promotion on an HTML page for display on the customer's display, step 630. The visual representation is then displayed on the customer's display, step 640. Embodiments of the visual representation of promotions on a customer display are illustrated in the above referenced provisional applications.

In the present embodiment, based upon the promotion information presented to the customer, the customer may select or click on the visual representation, step 650. In one embodiment, after the customer clicks on the visual representation, the customer is presented with a web page that allows the customer to fulfill the pre-condition, step 660. For example, the promotion may specify that if the customer buys two battery packs, the customer will save $1.50. Then when the customer clicks on the visual representation, the customer is presented with a page listing battery packs offered for sale.

In this embodiment, the consumer may then select or put the items into her shopping cart to attempt to fulfill the pre-conditions of the promotion, step 670. Alternatively, the user may navigate backwards and/or continue shopping without fulfilling the pre-conditions.

In this embodiment, after items are placed in a customer shopping cart, it is typically evaluated, step 680. In particular, merchant server 140 causes a reevaluation of the customer's shopping cart, and the application server invokes a method of a Service object to determine the amount of savings provided to the customer. If pre-conditions for coupons are fulfilled by the shopping cart, the appropriate savings are added to the evaluation. The amount of savings is retrieved by merchant server 140 and displayed to the customer, step 690.

In another embodiment, when the customer clicks on the visual representation, the appropriate items may automatically be placed into her shopping cart. For example, the promotion may specify that if the customer buys a blue pen, they will get a red one for free. Thus when the customer clicks on the visual representation of the promotion, the customer's shopping cart is automatically loaded with a blue pen and with a red pen.

In the present embodiment, the consumer may continue shopping or checkout, step 700.

For POS systems, in the present embodiment, loyalty card system 90 receives and implements the promotion, step 770. As discussed above, typically commercial implementations of loyalty card system 90 have different ways and formats for defining promotions. It is envisioned that central data server 150 will format the promotion in the correct format specified by a specific POS system.

In the present embodiment, based upon the promotion specification, loyalty card system 90 will notify the selected or targeted customers of a promotion, step 780. For example, the customer may be informed through via an e-mail message, a telephone call, or a fax at home, work, or otherwise; via a direct-mailing, via an in-store kiosk (after identifying herself); a wireless device such as a cell phone, personal digital assistant (PDA), pager, or the like; via targeted advertising in-line POS line; or other method implemented by loyalty card system 90. It is envisioned that loyalty card system 90 should be able to efficiently receive the promotion data, and execute the promotion to target the selected customers. In some embodiments, loyalty card system 90 may be coupled to companies that specialize in direct mailing, e-mailing, or the like, and customers may be notified of promotions on behalf of loyalty card system 90 by such specialized companies.

As illustrated in FIG. 1, in some embodiments, customers may be informed of promotions via direct mailing, e-mailing, paging, etc., as directed by data server 150. Similar to the above, it is envisioned that data server 150 may rely upon companies that specialize in promotion distribution to notify customers of promotions. The promotion data, customer contact information, and the like may be sent to such specialized companies from data server 150, from loyalty card system 90, or other source.

Next, during the customer's shopping visit, the customer may select items (physical items, tokens, receipts, etc.) to purchase, rent, lease, or otherwise, in any conventional manner, step 790. At time of check-out, the customer may identify herself to the POS system in any conventional manner, step 800. For example, the customer may swipe her loyalty card through a magnetic or optical reader; the customer may swipe her credit or debit card through a reader; the customer may enter her telephone number, social security number, loyalty card number, a password, or the like; the customer may provide biometric data such as a finger print, a voice print, iris scan, or the like. The check-out may be at a traditional POS register, a self check-out kiosk or area, or any other location that the customer may identify herself, conduct a transaction, or the like. 1

Next, in the on-line world or brick-and-mortar world, when the consumer desires to checkout, the items being purchased (leased, etc.) are evaluated, step 710. In the on-line world, it is envisioned that the customer, by this time, would have identified herself to the on-line shopping system via log in, user name, password, or the like. If the conditions of the promotion are met, the benefit is provided to the customer, i.e. the promotion is redeemed. For example, for an on-line shop, merchant server 140 causes application server 180 to use the instances of promotion objects that were created. In particular, an evaluate method of a Service object is invoked, and the amount of savings is calculated. The savings is then retrieved by merchant server 140 and displayed to the consumer. In the brick-and-mortar store, if the items purchased by the customer fulfill the conditions of promotion offered to that customer, loyalty card system 90 provides the benefit to the customer.

In the present embodiment, when the consumer checks out, a promotion usage condition, application server 180/loyalty card system 90 stores data associated with the transaction, step 720. For example, application server 180/loyalty card system 90 may record the items of the shopping cart, the dollar amount of the items, the number of items, the customer identification and/or customer demographic data, the shopping time, the promotions viewed, the promotions used by the customer, and the like.

In the present embodiment, periodically, data server 150 collects data from applications servers running the promotions, loyalty card systems, or the like, step 730. In some embodiments, the data collection may be on demand, may be periodic, such as hourly, daily, weekly, or the like. In other embodiments, the data collection may be based upon a number of redemptions, such as every time a promotion has been redeemed, every fifth time the promotion has been redeemed, or the like. In the embodiment, the data passed back may include the customer's shopping cart specifics, the customer's demographics, promotions accepted, and the like.

Data server 150 processes the promotion redemption data when it receives the data, step 740. In other embodiments, the redemption data is batched processed, for example at off-peak times. In the present example, processing of the promotion redemption data may include populating one or more data tables in a transactional database. Additionally, a number of predetermined processing functions may be performed on the transaction data to populate one or more data marts, generate subscribed reports, generate alerts, or the like.

In one embodiment of the present invention, periodically, promoter server 100 contacts data server 150 and retrieves reports describing the promotion's progress and/or success, step 750. In another embodiment, a promoter may contact data server 150 to access a data mart or the transactional data base, view portal data, and run one or more reports on the data. In other embodiments of the present invention, promoter may automatically receive reports from data server 150 based upon defined alerts, conditions, or the like. These reports may be specified and/or subscribed to by the promoter, or other party.

The promoter (or third party authorized by the promoter) may receive data regarding the progress of their promotions every day, every two days, every week, near real-time and the like. As above, in this embodiment, the transactional data such as shopping cart contents of each customer, the customer's demographics, the dollar amount of the promotion used, and the like are also accessible. Based upon such data, the promoter may modify current promotions in near real-time, adjust future promotions, and the like, to better target the desired customers. In some embodiments, the promotions may also be expanded to a larger customer base, such as new targeted customers, new on-line stores, new loyalty card systems, and the like.

In the foregoing specification, the invention has been described with reference to specific exemplary embodiments thereof. Many changes or modifications are readily envisioned. For example, as illustrated in FIG. 3, a merchant/retailer may also set up their own promotions in the same way as a promoter. Thus for example, instead of the promotion being specified by promoter 100, the promotion, such as an in store coupon, is specified by a merchant. The merchant may be at merchant server 130 or 140, or even another computer coupled to data server 150 via computer network 160.

The embodiments allow for simultaneous creation of promotions for both on-line merchants, and brick-and-mortar merchants (via loyalty card system 90). Additionally, the above embodiments describe that redemption data from both on-line merchants and brick-and-mortar merchants can be downloaded to data server 150 for analysis. In other embodiments, promotions targeted to only brick-and-mortar merchants or only to on-line merchants can be defined, implemented, redeemed, and analyzed.

Embodiments of the present invention may provide information to the user or consumer more than just promotional information. For example, embodiments may give suggestions such as recipes, related foods, suggested food courses; information in the form of text, video, audio, or the like; URLs of web pages for information; and the like.

Further, embodiments of the present invention may be applied to other areas than for purchase of goods, such as for rental or lease of real property, tangible property, or intangible property, for purchasing or contracting for services, for any financial or barter transaction, for any recommendations such as stock picks or sports betting, for non-profit or volunteer activities, for any application in which a user may benefit by the presentation of additional or related information, and the like.

Further embodiments may be implemented entirely within in-house brick and mortar store servers. Accordingly, the merchant servers, the central data server, and the application server may be owned or operated by one company or related companies. Further, the POS servers and the central data server may be owned or operated by one company or related companies. For example, a neighborhood grocer may provide one or more information terminals to shoppers. Based upon the shoppers shopping habits, demographics, or the like, the shopper may be informed that the grocer is offering them a promotion, e.g. buy three, get one free, or the like. Upon check out, if the shopper fulfills the pre-conditions of the promotion, the shopper is automatically given the benefit. Such embodiments can utilize the above described infrastructure to provide such service for on-line or retail stores.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention. Additional disclosure regarding implementation details is attached in the appendicies.

The specification and drawings are, accordingly, to be regarded in an illustrative rather than a restrictive sense. It will, however, be evident that various modifications and changes may be made thereunto without departing from the broader spirit and scope of the invention as set forth in the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for an integrated promotion system comprises:
receiving a specification of a promotion in a central server from a promoter system coupled via a computer network, the specification of the promotion including a promotion identifier, and a customer targeting criteria;
determining in the central server, a point of sale server destined for the promotion, in response to the customer targeting criteria;
converting the specification of the promotion in the central server into a point of sale data packet appropriate for the point of sale server;
providing the point of sale data packet to the point of sale server via a computer network;
providing notice of a promotion to a first targeted customer in the point of sale server in response to the point of sale data packet;
providing a promotion benefit to the first targeted customer when the first targeted customer meets preconditions of the promotion;
storing in the point of sale server, transaction data of the first targeted customer, when the first targeted customer meets the preconditions of the promotion;
uploading the transaction data of the first targeted customer to the central server via a computer network;
generating a promotion report in the central server, in response to the transaction data of the first targeted customer; and
providing the promotion report to the promoter system via a computer network.

2. The method of claim 1 further comprising:
receiving a revised specification of the promotion in the central server from the promoter system via a computer network, wherein the revised specification is generated in response to the promotion report.

3. The method of claim 1 wherein providing the promotion report to the promoter system comprises an action selected from the group: populating a data mart, issuing an alert, fulfilling a report subscription request, providing a web portal.

4. The method of claim 1 wherein receiving the specification of the promotion comprises:
providing a plurality of web pages to the promoter system, the plurality of web page comprising at least one web form; and
receiving a web form submission in the central server in response to the web form.

5. The method of claim 1 wherein providing notice of the promotion to the first targeted customer in the point of sale server comprises an action selected from the group: emailing the first targeted customer, direct-mailing the first targeted customer, displaying promotions to the first targeted customer, electronically communicating with the first targeted customer via wireless device, playing a recorded message to the first targeted customer.

6. The method of claim 1 further comprising receiving approval of the promotion prior to providing the point of sale data packet to the point of sale server.

7. The method of claim 1 further comprising:
converting the specification of the promotion into another point of sale data packet, wherein the other point of sale data packet is appropriate for another point of sale server; and
providing the other point of sale data packet to the other point of sale server;
wherein a format for the point of sale data packet and a format of the other point of sale data packet are different.

8. The method of claim 7 further comprising:
providing notice of the promotion to a second targeted customer in the other point of sale server in response to the other point of sale data packet;
providing the promotion benefit to the second targeted customer when the second targeted customer meets the preconditions of the promotion; and
storing in the other point of sale server, transaction data of the second targeted customer, when the second targeted customer meets the preconditions of the promotion.

9. The method of claim 8 further comprising:
uploading the transaction data of the second targeted customer to the central server via a computer network; and
wherein generating the promotion report in the central server comprises generating the promotion report in the central server, in response to the transaction data from the first targeted customer and the second targeted customer.

10. The method of claim 1 wherein the promotion benefit is selected from the group comprising:
specifying promotion objects in response to the specification of the promotion;
providing the promotion objects in an application server coupled to a merchant server; and
instantiating promotion objects in response to the promotion objects when a customer coupled to a merchant server selects the promotion.

11. An integrated promotion system comprises:
a data server configured to receive a specification of a promotion from a promoter system via a computer network, wherein the specification of the promotion including promotion targeting criteria, wherein the data server is configured to determine a point of sale system where the promotion is to be sent in response to the specification of the promotion, and wherein the data server is configured to form a promotion data packet compatible with the point of sale system; and
a point of sale server coupled to the data server configured to receive the promotion data packet from the data server via a computer network, wherein the point of sale server is configured to implement the promotion in response to the promotion data packet, configured to direct notification of the promotion to a first targeted customer, configured to provide a promotion benefit to the first targeted customer when the first targeted customer fulfills preconditions of the promotion; and configured to store promotion fulfillment data;
wherein the data server is also configured to receive the promotion fulfillment data from the point of sale server, configured to process the promotion fulfillment data; and configured to allow the promoter system to view the promotion fulfillment data via a computer network.

12. The integrated promotion system of claim II wherein the data server is also configured to receive a revised specification for the promotion from the promoter system, wherein the revised specification is generated in response to the promotion fulfillment data.

13. The integrated promotion system of claim 12 wherein the data server is configured to process the promotion fulfillment data in a configuration selected from the group:
configured to populate a data mart in response to the promotion fulfillment data;
configured to detect an alert condition and is configured to generate an alert when the alert condition is detected;
configured to generate a report in response to the promotion fulfillment data and is configured to send the report to one or more subscribers; and
configured to populate a web portal in response to the promotion fulfillment data.

14. The integrated promotion system of claim 11 wherein notification of the promotion to the first targeted customer is selected from the group: sending an e-mail message to the first targeted customer, sending a postal mail message to the first targeted customer, sending a wireless message to the first targeted customer, playing a recorded audio message to the first targeted customer, displaying a message to the first targeted customer.

15. The integrated promotion system of claim 11
wherein the data server is also configured to determine another point of sale system where the promotion is to be sent in response to the specification of the promotion, and wherein the data server is configured to form another promotion data packet compatible with the other point of sale system; and
wherein the system further comprises the other point of sale server coupled to the data server configured to receive the other promotion data packet from the data server via a computer network, wherein the other point of sale server is configured to implement the promotion in response to the other promotion data packet, wherein the other point of sale server is configured to direct notification of the promotion to a second targeted customer, wherein the other point of sale server is configured to provide the promotion benefit to the second targeted customer when the second targeted customer fulfills preconditions of the promotion; and wherein the other point of sale server is configured to store other promotion fulfillment data.

16. The integrated promotion system of claim 15 wherein the data server is also configured to receive the other promotion fulfillment data from the other point of sale server; and configured to process the promotion fulfillment data and the other promotion fulfillment data.

17. The integrated promotion system of claim 11 wherein the promotion targeting criteria is selected from the group comprising: customer loyalty to specific product, customer loyalty to product category, customer shopping frequency, customer shopping cart size, customer usage of products in product categories, customer usage of specific products.

18. The integrated promotion system of claim 17
wherein the data server is configured to provide a web form to the promoter system via a computer network, and
wherein a promoter uses the web form to provide the specification of the promotion.

19. The integrated promotion system of claim 11
wherein the data server is also configured to determine an application server where the promotion is to be sent in response to the specification of the promotion; and
wherein the integrated promotion system further comprises the application server, the application server configured to receive the promotion from the data server via a computer network; the application server is configured to implement the promotion, the application server is configured to direct notification of the promotion to a second targeted customer, configured to provide a promotion benefit to the second targeted customer when the second targeted customer fulfills preconditions of the promotion; and configured to store additional promotion fulfillment data; and
wherein the data server is configured to receive the additional promotion fulfillment data from the application server.

20. The integrated promotion system of claim 19
wherein the data server is also configured to receive the additional promotion fulfillment data; and configured to process the promotion fulfillment data and the additional promotion fulfillment data.

21. A method for a promotion system comprises:
receiving a specification of a promotion in a central server from a promoter system coupled via a computer network the specification of the promotion including targeting criteria;
determining in the central server servers where the promotion will be distributed to in response to the targeting criteria, the servers including a loyalty card server and an application server;
formatting the promotion into a first data packet appropriate for the loyalty card server;
formatting the promotion into a second data packet appropriate for the application server;
providing the first data packet to the point of sale server via a computer network;
providing the second data packet to the application server via a computer network;
providing notice of the promotion to a first targeted customer in the loyalty card server in response to the first data packet;
providing a promotion benefit to the first targeted customer when the first targeted customer meets preconditions of the promotion;
storing in the loyalty card server, transaction data associated with the first targeted customer, when the first targeted customer meets the preconditions of the promotion;
providing notice of the promotion to a second targeted customer in a merchant server coupled to the application server in response to the second data packet;
storing in the application server, promotion impression data associated with the second targeted customer, when the second targeted customer is presented with a description of the promotion;
uploading the transaction data associated with the first targeted customer to the central server via a computer network;
uploading the promotion impression data associated with the second targeted customer to the central server via a computer network;
generating a promotion report in the central server, in response to the transaction data of the first targeted customer and in response to the promotion impression data associated with the second targeted customer; and
providing the promotion report to the promoter system via a computer network.

22. The method of claim 21 further comprising storing in the loyalty card server, promotion impression data associated with the first targeted customer, when the first targeted customer is presented with the description of the promotion.

23. The method of claim 22 wherein the transaction data associated with the first targeted customer comprises data selected from the group: contents of a shopping cart associated with the first targeted customer, a currency value representing a value of goods in the shopping cart, demographic data of the first targeted customer.

24. The method of claim 21 further comprising:
receiving in the loyalty card server a customer identifier for the first targeted customer;
retrieving customer data associated with the first targeted customer, in response to the customer identifier; and
determining whether the customer data meets conditions of promotion;
wherein providing notice of the promotion to a first targeted customer comprises providing notice of the promotion to the first targeted customer in the loyalty card server when the customer data meets conditions of the promotion.

25. The method of claim 24 wherein the conditions of the promotion comprise conditions selected from the group: customer shopping cart value, customer shopping profile, customer product loyalty, customer product class frequency.

26. The method of claim 24 wherein generating a promotion report in the central server comprises an action selected from the group:
populating a data mart in response to the promotion report;
determining an alert condition and generating an alert when the alert condition is detected;
generating a report in response to the promotion report and sending the report to one or more subscribers; and
populating a web portal in response to the promotion report.

27. The method of claim 21 further comprising:
receiving a specification of another promotion in the central server from another promoter system coupled via a computer network, the specification of the other promotion including additional targeting criteria;
wherein determining in the central server servers where the promotion will be distributed to comprises determining in the central server servers where the promotion will be distributed to in response to the targeting criteria and to the additional targeting criteria.

28. The method of claim 27 wherein either the promotion or the other promotion are formatted and provided to the point of sale server via a computer network.

29. The method of claim 27 wherein either the promotion or the other promotion are formatted and provided to the application server via a computer network.

30. The method of claim 27 further comprising:
providing notice of the promotion to a third targeted customer in the loyalty card server in response to the first data packet;
storing in the loyalty card server, promotion impression data associated with the third targeted customer, when the third targeted customer is presented with the description of the promotion; and
uploading the promotion impression data associated with the third targeted customer to the central server via a computer network.
